(19) United States
(12) Patent Application Publication
(10) Pub. No.: US 2016/0311188 A1
(43) Pub. Date: Oct. 27, 2016

(54) LIGHTWEIGHT STRUCTURE AND METHOD FOR PRODUCING A LIGHTWEIGHT STRUCTURE

(71) Applicant: Johann Schwöller, Strasswalchen (AT)

(72) Inventor: Johann Schwöller, Strasswalchen (AT)

(21) Appl. No.: 15/027,812

(22) PCT Filed: Oct. 8, 2014
(86) PCT No.: PCT/EP2014/071575

§ 371 Date: Jul. 1, 2016

(30) Foreign Application Priority Data
Oct. 8, 2013 (AT) A 50647/2013

(51) Int. Cl. B29D 99/00; B64C 3/18; B29C 65/48; B29C 63/00; B29C 70/30; B29C 65/00

(52) U.S. Cl. CPC B29D 99/0021; B29C 70/30; B29C 66/721; B29C 65/48; B29C 63/0026; B64C 3/185; B64C 3/182; B29L 2031/3076

(57) ABSTRACT

The lightweight structure according to the invention has at least one substantially plate-shaped structural wall and an enveloping element. The structural wall and the enveloping element are each made of a fibrous composite material. The structural wall is formed from a first fiber outer layer, an intermediate layer and a second fiber outer layer. At least in a sub-region of the end face of the structural wall, a U-shaped profiled connection section (connection section) having a base wall and two side walls is provided. The base wall is arranged to rest against the end face of the structural wall, and the side walls of the U-shaped profiled connection section are arranged to rest against the outer surfaces of the first and second fiber outer layers and are joined to the fiber outer layers.

The present invention relates to a lightweight structure and a method for producing a lightweight structure, in particular for aircraft.

It is known that lightweight structures are produced by reinforcing enveloping elements, such as the skin of an aerofoil of aircraft, with plate-shaped reinforcing ribs or the like, which are substantially arranged perpendicular to the enveloping element. An extremely lightweight structure is obtained by using fibrous composite materials, i.e. plate-shaped components consisting of thin carbon fiber layers or glass fiber layers with a foam layer placed in between. Depending on the degree of lightweight design, this intermediate foam layer may be a honeycomb structure or a tubular material. Such a structure is, for example, described in WO 03/018295 A. The production of such structures is complicated and cost-intensive, however.

In order to be able to absorb the tensile and compressive loads of the reinforcing component for the bending stress of the shell, strands of fibrous composite materials are applied to the outer zones of the reinforcing component, e.g. a spar; the height of these has to be dimensioned such that the tensile and compressive forces can be absorbed, but that there is nevertheless enough bonding surface at the side of this insert for a secure bonding to the outer layers. This involves complex manual labor, if a usable weight-to-strength ratio is to be obtained.

By using this construction, however, a very narrow web surface of the reinforcing component is obtained for joining it to the enveloping element. The internal sandwich layers of such enveloping elements or shell structures are, however, usually very thin and can often not absorb the compressive, tensile or shear loads owing to the narrow webs of the reinforcing element. As a result, it is usually impossible to install a core element in this region of the shell for direct bonding to the outer layer. In order to obtain an adequate bending and buckling strength in this bonding region, however, additional layers of fibrous composite material have to be installed, thereby increasing the weight of the component. This recessing of the sandwich material in this region and the installation of the reinforcing material require a considerable additional effort and expense in production.

From U.S. 2008/0295334 A1, a method is known in which two structural elements, e.g. a frame element and a skin of an aircraft wing, are joined together. In this method, a U-shaped rail which laterally extends slightly beyond the side faces of the frame element is placed on the frame element in the region of the end face. This rail forms a wide surface which is used for joining to the second structural elements, the joint being produced by adhesive bonding.

WO 2012/091695 A1 discloses a similar joining device comprising lugs laterally projecting on a structural component for providing as large as possible a surface for joining to a further component.

U.S. 2004/0051005 A1 describes a device for securing metal parts to the surface of a sandwich panel. The joining device comprises L- and U-shaped fiber-reinforced layers which are placed into one another and bonded to one another and to the sandwich panel, thereby creating a location for the metal part.

Three-dimensional bodies for joining fibrous composite parts are further known from U.S. 2003/0037867 A1 and DE 10 2005034621 B3.

U.S. 2005/0064134 A1 discloses a device, a system and a method for joining components with a prong-shaped tensile joint. This joint comprises a base element and a prong-shaped element. The tensile joint is bolted and/or bonded to a plate-shaped component and connected by a tensile tape. Via the tensile joint, tensile forces from the plate-shaped component are absorbed and introduced into the tensile tape.

In building smaller to medium-sized aircraft, however, a lightweight structure in which walls consisting of a first fiber outer layer, an intermediate layer and a second fiber outer layer are used has become prevalent, with elongated fiber tapes being inserted between the opposite fiber outer layers in the region of the end faces of the structural walls. The elongated fiber tapes absorb tensile forces along the longitudinal direction of the structural walls.

The invention is based on the problem of creating a lightweight structure and a method for producing a lightweight structure, in particular for aircraft, by means of which method a very stable and light lightweight structure can be produced efficiently.

This problem is solved by a lightweight structure and a method according to the independent claims. Advantageous variants of the invention are specified in the respective dependent claims.

The lightweight structure according to the invention has at least one substantially plate-shaped structural wall and an enveloping element. The structural wall and the enveloping element are each made of a fibrous composite material. The structural wall is formed from a first fiber outer layer, an intermediate layer and a second fiber outer layer. At least in a sub-region of the end face of the structural wall, a U-shaped profiled connecting or reinforcing section having a base wall and two side walls is provided. The base wall is arranged to rest against the end face of the structural wall, and the side walls of the U-shaped profiled connection section are arranged to rest against the outer surfaces of the first and second fiber outer layers and are joined to the fiber outer layers.

The enveloping element comprises a fibrous composite reinforcing tape in the region of which the enveloping element and the structural walls are joined to one another, the end face of the structural wall resting against the fibrous composite reinforcing tape.

Compared to the structural walls described above, into which reinforcing tapes extending along the entire length of the structural wall are integrated at their end faces, the lightweight structure according to the invention can be produced considerably more easily and quickly, because the fibrous composite reinforcing tape can be laminated flatly onto the enveloping element. This is considerably simpler than the arrangement and bonding of elongated fiberss between the fiber outer layers of the structural wall.

The fibrous composite reinforcing tape can in principle have any width and any strength for absorbing tensile forces. The structural walls themselves do not have to absorb any tensile forces, but they only have to hold the enveloping element in position and preferably maintain a distance between two opposite enveloping elements. The U-shaped profiled connection section establishes a firm connection between the enveloping element and the structural wall. As forces are only introduced into the structural wall in the plane of the structural wall, and the proportion of forces in the longitudinal direction of the structural wall is low, because the tensile forces are absorbed by the fibrous composite reinforcing tape in the longitudinal direction of the structural wall, the surface of the base wall of the U-shaped profiled connection section is sufficient for joining the structural walls to the enveloping element.

The structural wall can initially be produced virtually completely by means of an automatic process. The structural wall is preferably joined to the enveloping element by bringing the not yet set fibrous composite reinforcing tape into contact with the structural wall under pressure. The fibrous composite reinforcing tape consists of reinforcing fibers embedded in a matrix material. The not yet set matrix material bonds to the end face of the structural wall and in particular to the U-shaped profiled connection section(s). An adhesive compound can be used in addition, however. This is particularly expedient if the structural wall is not at a right angle to the enveloping element, so that a wedge-shaped gap between the end face of the structural wall and the enveloping element is filled.

In the lightweight structure according to the invention, the tensile forces are decoupled from the structural wall. It is therefore possible to arrange several structural walls with a slight mutual offset on a common fibrous composite reinforcing tape, because the tensile forces are absorbed by the fibrous composite reinforcing tape across the offset. This offers constructive design opportunities which were not available in known lightweight structures.

The U-shaped profiled connection section is preferably made of a fibrous composite material. The fiber direction of this element is preferably diagonal to the longitudinal dimension of the U-shaped profiled connection section, so that the residual tensile/compressive forces can be optimally introduced into the structural components by the longitudinally oriented reinforcing tape.

The fibrous composite reinforcing tape preferably extends parallel to the structural wall along the entire length or width of the enveloping element (or only a part of the length of the structural component).

The U-shaped profiled connection section can be formed from two L-shaped profiled connection sections, the region of the end face of the structural wall being overlapped by one leg each to form the base.

Several U-shaped profiled connection sections can be arranged in sections at the end face of the structural wall.

The U-shaped profiled connection sections can be arranged in sections at the end face of the structural wall with mutual spacing.

The U-shaped profiled connection section can be slotted in the region of the side wall, so that it is flexible in the region of the base. Because of this, various three-dimensional shapes and in particular curvatures can be formed with the end faces of the structural walls. As the fibrous composite reinforcing tape is flexible before it is joined to the enveloping element, it can in principle adopt virtually any shape before setting. The lightweight structure according to the invention therefore offers virtually unlimited design opportunities.

The structural walls are preferably produced by laminating the intermediate layer to the two fiber outer layers and letting it set, followed by cutting it to the desired shape. Large plates of fibrous composite material can therefore be produced, out of which several structural walls are then cut. The structural walls are preferably cut fully automatically, using suitable cutting or milling machines.

The structural wall is preferably produced by using a filler material, such as a foam material, as an intermediate layer and by cutting at least one hole into the filler material, into which hole a reinforcing body of a material stronger than the filler material is installed, whereupon the filler material together with the reinforcing body is laminated to the two fiber outer layers and set.

This aspect of the invention can also be used for other lightweight structures in which the structural wall is not joined to an enveloping element by means of a U-shaped profiled connection section according to the invention. The installation of a reinforcing body into the filler material prior to the lamination of the fiber outer layers therefore represents an independent inventive idea. The filler material may be a foam, a honeycomb or tubular material or another material capable of transmitting transverse forces from one fiber outer layer to another fiber outer layer, thereby reliably maintaining a distance between the fiber outer layers. A wooden body, a metallic, in particular aluminum, body and/or a fibrous composite body can be used as reinforcing body. The fibrous composite body in turn consists of a filler material surrounded by a fiber outer layer. The thickness of such a fibrous composite body matches that of the filler material, which can therefore be installed flush with its surface.

Several structural walls are preferably assembled to form a skeleton. The skeleton is then joined to the enveloping element, and at least one fibrous composite reinforcing tape extends substantially parallel to a structural wall. For this purpose, the individual structural walls do not have to be joined to one another permanently. A plug connection or a provisional adhesive bond is sufficient. The corners of the plug connection can be bonded to ready-made angle sections. The strength of the whole lightweight structure is obtained by joining the enveloping element at several points to the structural wall or preferably to the several structural walls.

It is in particular provided that the skeleton, together with the integrated mechanical, hydraulic, electronic and electric components of a vehicle, in particular of an aeroplane or aircraft, is placed on a region of the enveloping element which forms a base wall of the enveloping element and on the fibrous composite reinforcing tapes arranged thereon, and that then a corresponding region of the enveloping element which forms a top wall and the fibrous composite reinforcing tapes arranged thereon are placed on the skeleton. This is followed by the setting or drying of the lightweight structure in the region of the base walls of the U-shaped profiled sections, the reinforcing tapes and the top and bottom walls of the enveloping element.

The aim of the present invention is therefore the shifting of the tensile and compressive forces from a component designed for flexural loads, such as an aerofoil spar, a reinforcing rib or a frame, into the enveloping element.

For this purpose, previous solutions involve the introduction of spars into the edge regions of which a belt of fibers, such as carbon or glass fibers or the like, is inserted in the production process. This belt of many individual strands, so-called ravings, had to be installed manually. In addition to being very labor-intensive, this construction has the disadvantage that a defined belt height has to be reached in order to transmit the thrust forces to the lateral carbon fiber coating. Because of this production method, each individual component had to be produced manually in molds, involving great effort and expense.

This design has the further disadvantage that all forces have to be introduced into the spars and the connection to the shell is limited to a small region, where the support material has to be removed and which requires additional reinforcement. This involves a considerable additional effort and cost even in shell construction.

The most essential point of the present invention is the shifting of the tensile and compressive forces from the spar edge region or the structural wall into the shell or the enveloping element.

This means that the structural wall can be cut out of a sandwich plate material in a very time- and cost-saving manner using a CNC milling machine. The structural wall now essentially only transmits the thrust forces from the top side to the underside and absorbs low shear forces. In contrast to prior art, however, the structural wall absorbs almost no tensile and compressive forces of the flexural load.

The tensile and compressive forces are absorbed by the fibrous composite reinforcing tape laminated onto the inner layer of the aerofoil or the enveloping element. As the belt is now considerably wider, forces can be introduced directly into the enveloping element, which can therefore be continuous without any interruption.

In order to reinforce exposed regions where no fibrous composite reinforcing tape has to be installed into the enveloping element, it is provided that a fibrous composite reinforcing tape is placed in the region between the end face of the structural wall and in particular between the end face and the base wall of the profiled connection section.

Here, too, the spar or the rib can be cut out of a sandwich plate material. In this case, the tensile and compressive forces are absorbed by a tension/compression tape, which lies within the U-section, however. When bonding the U-section, this tape can be placed on the cut-out component. For this purpose, a wet laminate can be installed into the U-section. In another variant, strips are cut from a plate with longitudinally oriented fibers and bonded between the U-section and the plate end when the U-section is affixed.

Such a structural wall can be placed at points in a lightweight structure where no fibrous composite reinforcing tape is provided on the enveloping element or where the structural wall does not rest against an enveloping element.

This method further offers the opportunity of producing curved edges in this way. The tension/compression tape is relatively thin in this case or produced in several thinner layers, and the U-section is incised straight or in a V-shape at the lateral edges. As a result of this thin design, the ready-made tension/compression tape can then be placed around the radii. As the radii get smaller, the tape can be installed as a wet laminate.

As the tensile and compressive loads are absorbed by the installed tape, the U-section can be incised laterally even if the end of the component is exposed. As a result, this construction is suitable for reinforcing the ends of fuselage bulkheads and the like, which have a curvature at the edges.

The invention is explained in greater detail below with reference to the figures, a which:

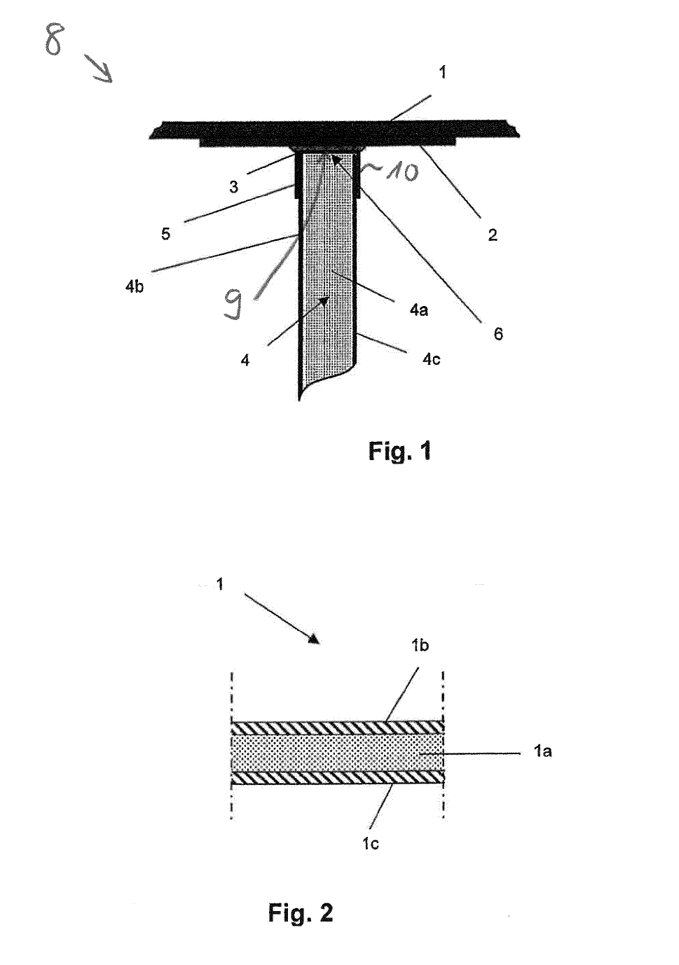

FIG. 1 is a laterally cut view of a section of a lightweight structure according to the invention;

FIG. 2 shows an enveloping element of the lightweight structure;

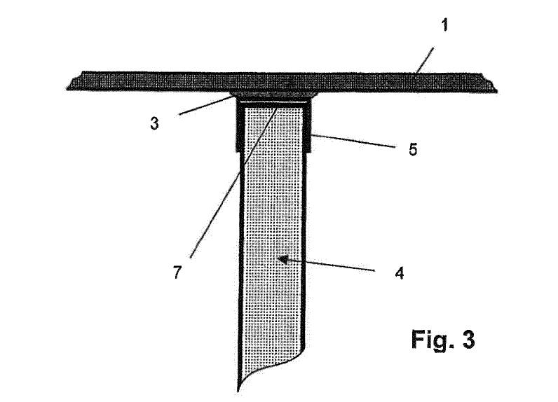

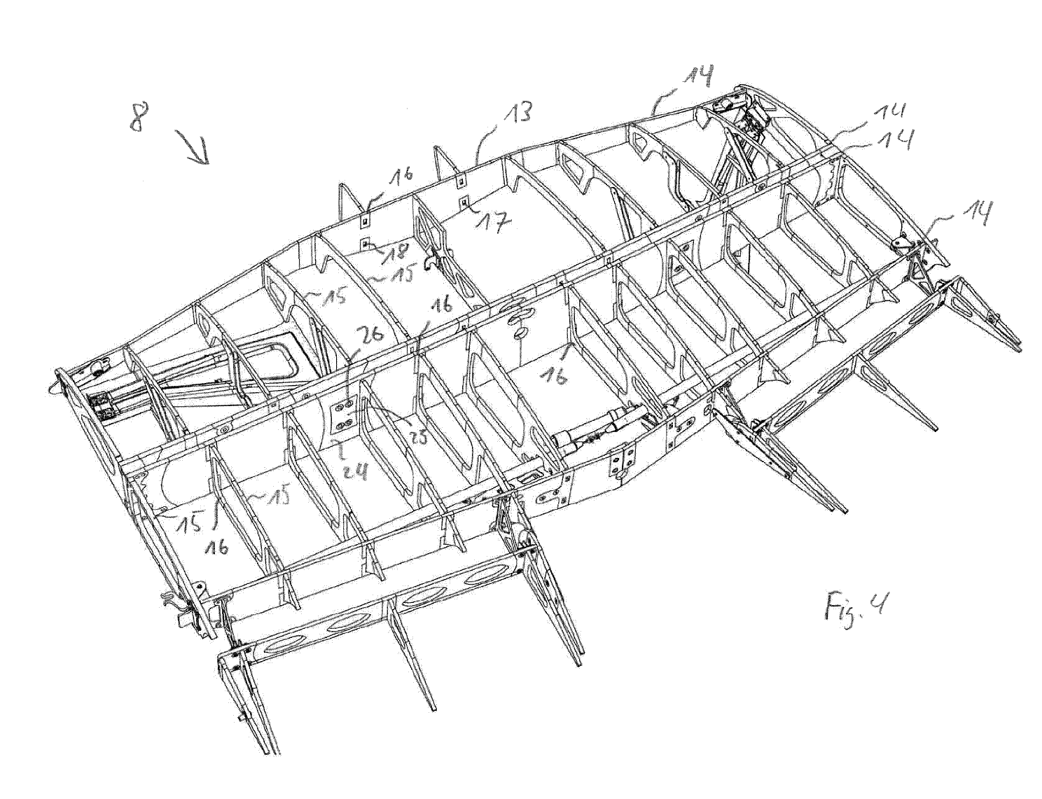

FIG. 3 is a laterally cut view of a section of a further embodiment of a light-weight structure according to the invention;

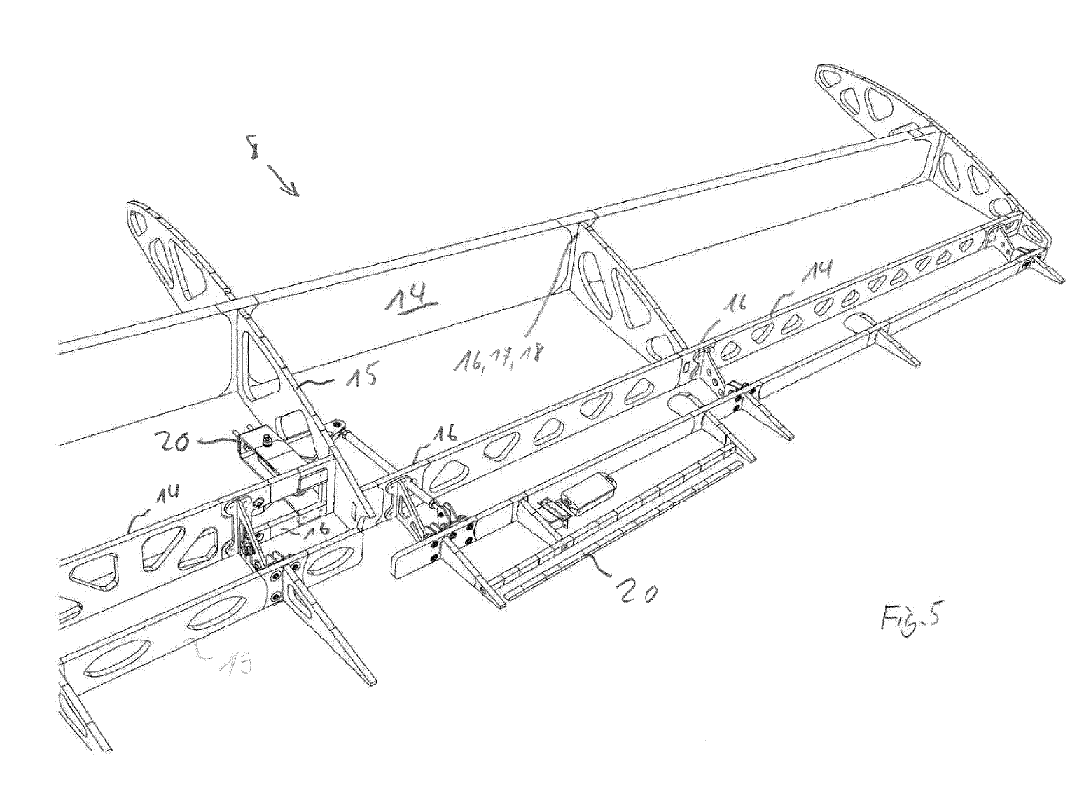

FIG. 4 is a perspective view of a central wing section of an aeroplane:

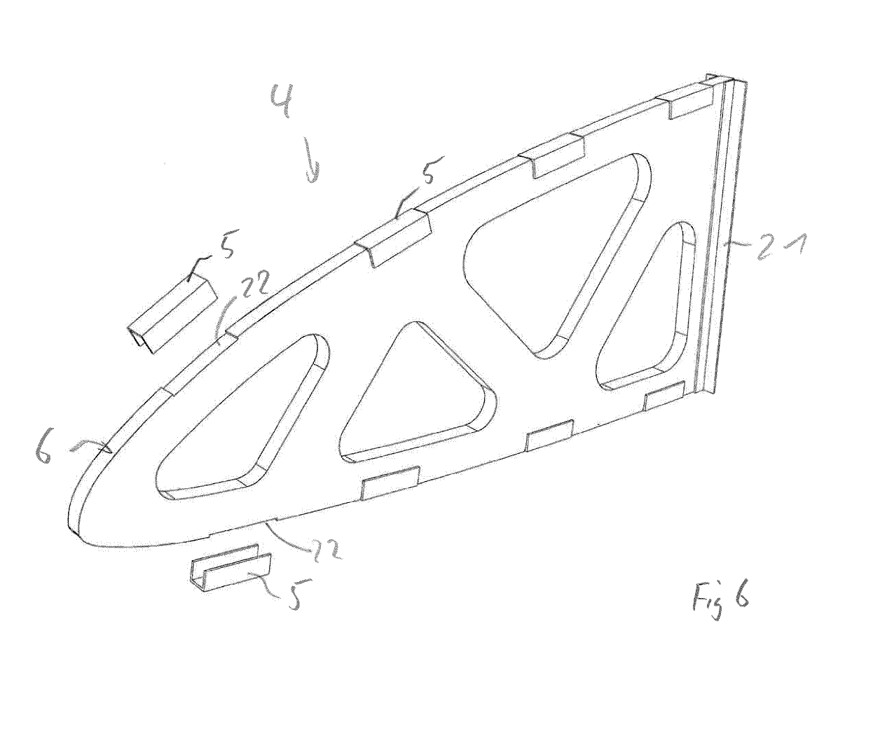

FIG. 5 is a perspective view of a lateral wing section of an aeroplane:

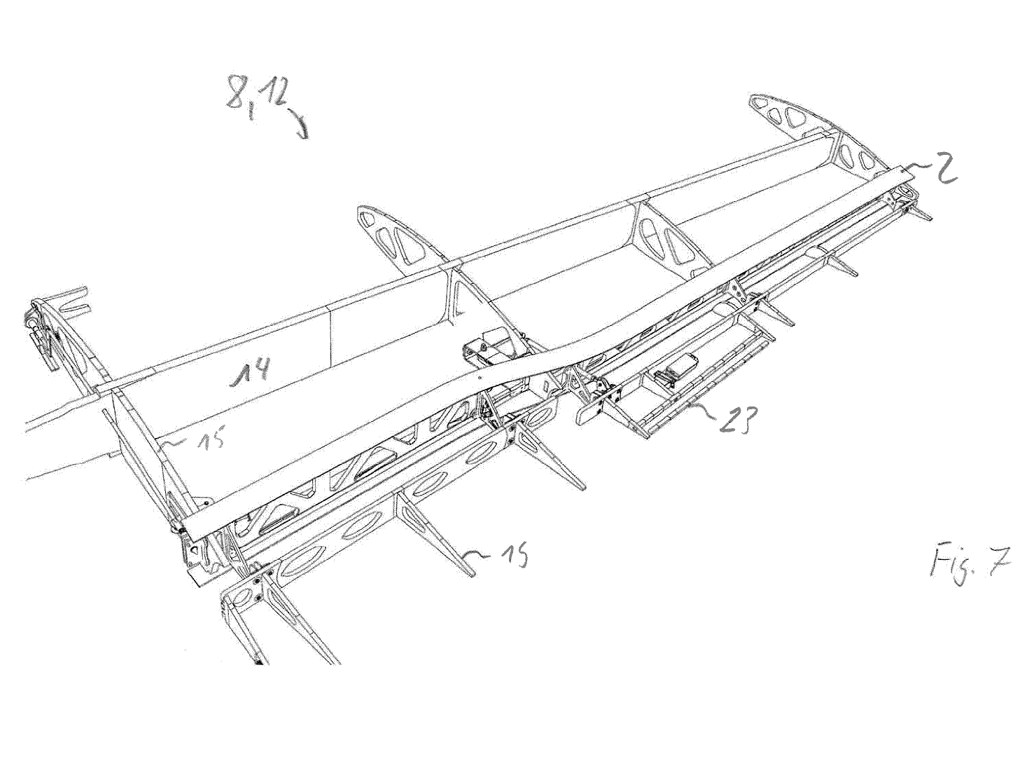

FIG. 6 is a perspective view of an embodiment of a plate-shaped structural wall of a lightweight structure;

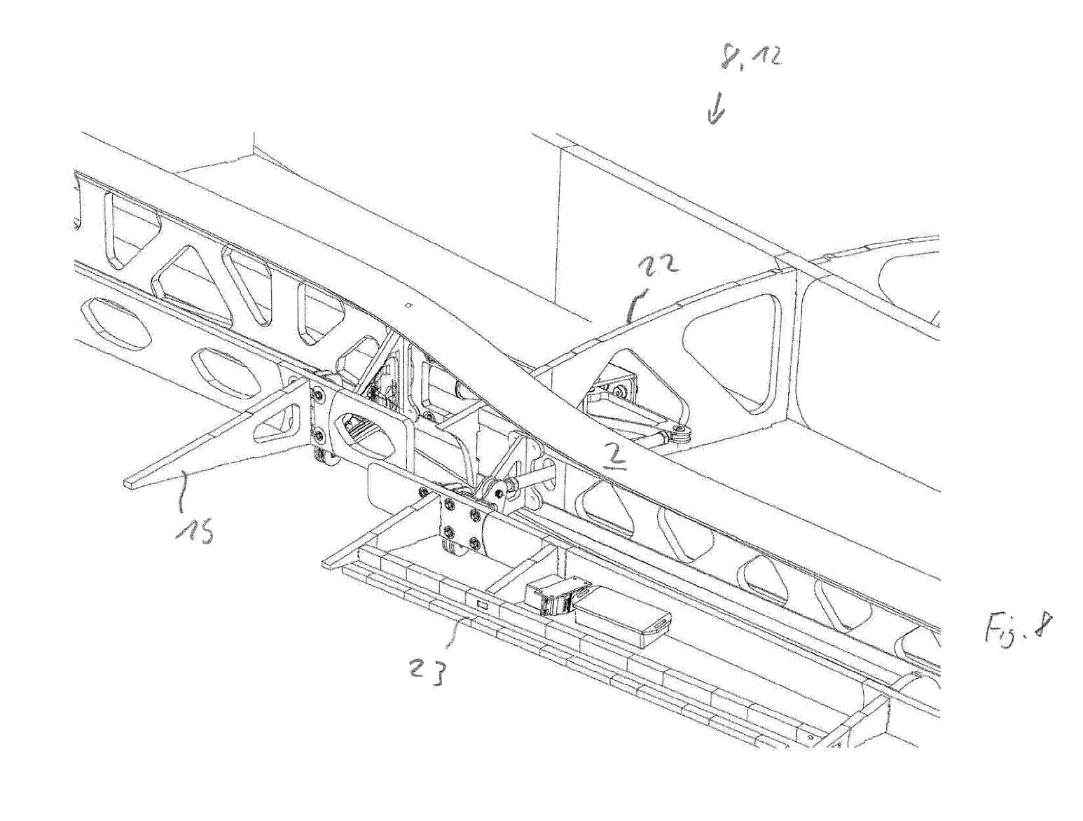

FIG. 7 is a perspective view of the lateral wing section from FIG. 5 with a fibrous reinforcing tape;

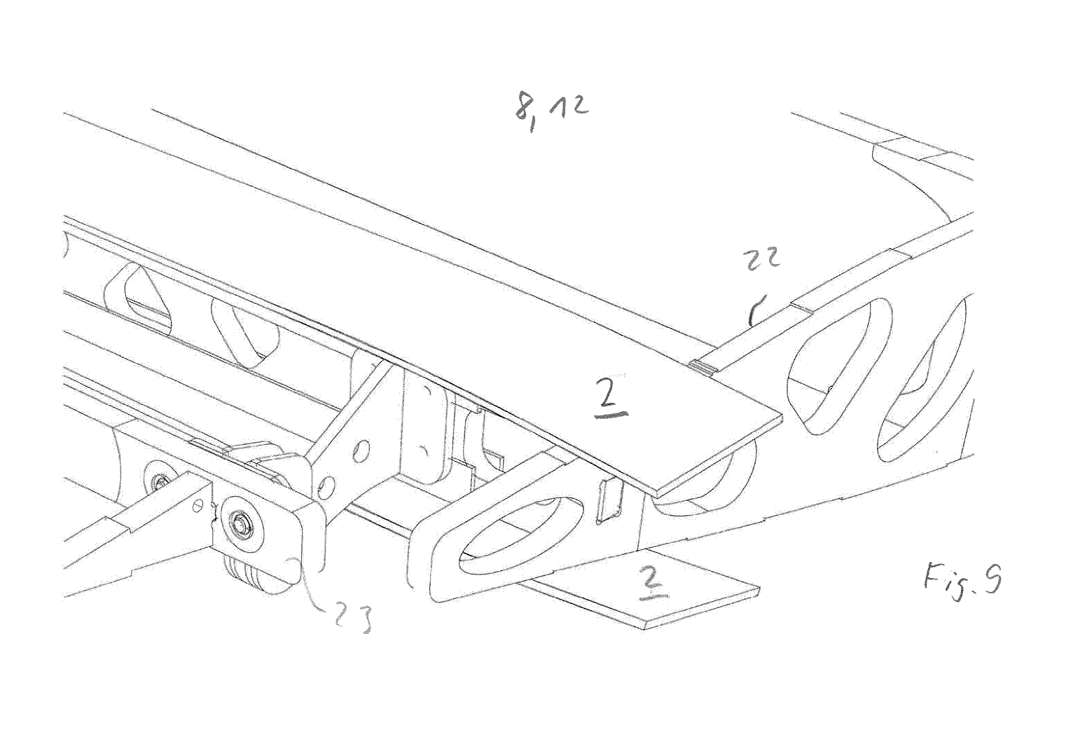

FIG. 8 shows a detail from FIG. 7 at a transition from one structural wall to another offset structural wall;

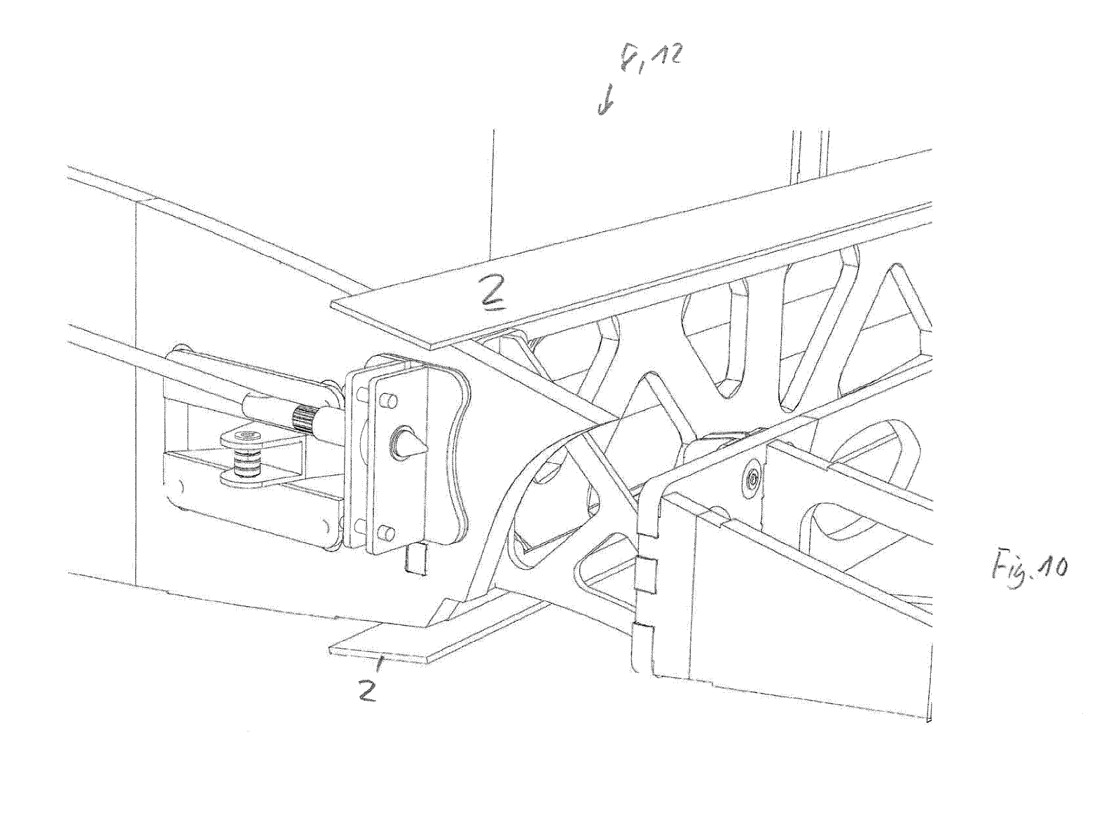

FIG. 9 shows a section from FIG. 7 with fibrous composite reinforcing tape applied to the top and to the underside of the lightweight structure; and

FIG. 10 shows a further detail from FIG. 7.

A lightweight structure 8 according to the invention (FIGS. 1 to 10) is described below. This lightweight structure 8 comprises at least one reinforcing component or a plate-shaped structural wall 4 and at least one enveloping element 1 (FIGS. 1 and 2).

The plate-shaped structural wall 4 is composed of a first fiber outer layer 4b, an intermediate layer 4a and a second fiber outer layer 4c.

A U-shaped reinforcing or profiled connection section 5 is located at an end face 6 of the plate-shaped structural wall 4.

The U-shaped profiled connection section 5 has a base wall 9 and two side walls 10.

The U-shaped profiled connection section 5 is preferably designed such that the two side walls are inclined towards one another relative to the base wall 9 by a predetermined angle of approximately 2° or 5° or 10°.

In this way, the U-shaped profiled connection section 5 has a certain preload which automatically holds the profiled connection section 5 in its position on the structural wall 4 after assembly. There is therefore no need for clips when mounting the profiled connection section 5 and joining it to the structural wall 4. Forces flow from the enveloping element 1 via the base wall 9 and the side walls 10 into the fiber outer layers 4b, 4c. The U-shaped profiled connection section 5 has reinforcing fibers extending diagonally to its longitudinal dimension, resulting in an optimum trans-mission of shear forces to the structural wall.

The profiled connection section 5 is placed in a sub-region of the end face 6 of the structural wall 4 in such a way that the base wall 9 and the side walls 10 correspondingly rest against the end face 6 or against the intermediate layer 4a, the first fiber outer layer 4b and the second fiber outer layer 4c and are secured thereto by means of an adhesive bond.

The enveloping element 1 is likewise composed of a first fiber outer layer 1b, an intermediate layer 1a and a second fiber outer layer 1c.

In a region where the enveloping element 1 is joined to the structural wall, there is further provided a reinforcing tape or a fibrous composite reinforcing tape 2. The fibrous composite reinforcing tape 2 is preferably made of a carbon fiber composite.

In the region of the fibrous composite reinforcing tape 2, the structural wall or the U-shaped profiled connection section 5 respectively is joined to the fibrous composite reinforcing tape 2.

The fibrous composite reinforcing tape 2 is preferably twice or three, four, five or six times as wide as the base wall 9 of the U-shaped profiled connection section 5.

According to a further embodiment of the lightweight structure 8 according to the invention, a fiber belt 7 of a structure similar to that of the fibrous composite reinforcing tape 2 can be provided in the region between the end face 6 of the structural wall 4 and the base wall 9 of the profiled connection section 5 (FIG. 5) in addition or as an alternative in particular. A structural wall 4 with such a fiber belt 7 can be provided in regions of the lightweight structure 8 where there is no fibrous reinforcing tape, nevertheless providing a certain degree of tensile stability.

Further embodiments and advantages of the lightweight structure 8 according to the invention are explained below with reference to a central wing section 11 and a lateral wing section 12. The wing sections 11, 12 comprise a skeleton 13 composed of structural walls 4 joined to one another.

The skeleton 13 of the central wing section 11 is composed of four transverse spars 14 extending perpendicular to the flight direction and joined to one another by a plurality of longitudinal spars 15 extending in the longitudinal direction of the aeroplane (FIG. 4).

The longitudinal spars 15 are designed such that reinforcing bodies made of wood are placed at the ends to be joined to the transverse spars 14. The reinforcing bodies 16 are provided with dowel-shaped connecting elements 17.

Wooden reinforcing bodies 16 having suitable recesses 18 for accommodating the connecting elements 17 of the longitudinal spars are correspondingly provided in the transverse spars 14 as well.

At the transitions from the transverse spars 14 to the longitudinal spars 15, angle sections 21 are provided for the location of the connecting elements 17 in the recesses 18 (FIG. 6).

Further functional and/or reinforcing bodies, such as metal bushes, can be inserted into the structural walls 4 and/or the reinforcing bodies 16.

In edge regions of the central wing section 11, metal bodies made of aluminum can be embedded as reinforcing bodies 16 into the transverse spars 14 and the longitudinal spars 15.

The skeleton of the lateral wing section 12 is composed of two transverse spars 14 extending perpendicular to the flight direction and joined to one another by a plurality of longitudinal spars 15 extending in the longitudinal direction of the aeroplane (FIG. 5).

The longitudinal spars 15 are designed such that reinforcing bodies made of wood are placed at the ends to be joined to the transverse spars 14. The reinforcing bodies 16 are provided with dowel-shaped connecting elements 17.

Wooden reinforcing bodies 16 having suitable recesses 18 for accommodating the connecting elements 17 of the longitudinal spars are correspondingly provided in the transverse spars 14 as well.

By way of example, a structural wall 4 of the central and lateral sections 11, 12 (FIG. 6) with connection sections 5 applied to their end face 6 is described below. To place the connection sections on the structural wall 4, location recesses 22 are formed in the end faces 6 of the structural wall 4. On one end face 6 of the structural wall, the angle sections 21 for joining the structural wall 4 to another structural wall 4 are shown. The angle sections 21 are bonded to the respectively adjoining structural walls 4. The angle sections are preferably made of a fiber-reinforced composite material.

A joining region of the lateral wing section 12 is described in greater detail below (FIG. 5).

The landing flap 19 and an aileron 23 as well as a corresponding actuating mechanism 20 are integrated into the lateral wing section 12.

In regions where the landing flap 19 is joined to the transverse spars 14, the transverse spars 14 are provided with suitable reinforcing bodies 16 made of wood, plastic or metal.

On the lateral wing section 12, the aileron 23 is secured in the same way to further transverse spars 14, these further transverse spars 14 being offset relative to the transverse spar 14 described above, to which the landing flap 19 is hinged.

To accommodate the actuating mechanism 20 for the landing flaps 19, an end region of this transverse spar 14 is provided with a reinforcing body 16 made of metal.

Where necessary, the fibrous composite reinforcing tapes 2 (FIGS. 7 to 10) are placed on the top side and the underside of the longitudinal and transverse spars, in particular on the U-shaped profiled connection sections 5 located thereon.

In the illustrated embodiment, the fibrous composite reinforcing tapes 2 are arranged along all transverse spars 14 (FIGS. 7 and 8 only show one fibrous composite reinforcing tape by way of example), and along the longitudinal spars 15 fibrous composite reinforcing tapes 2 are provided in the longitudinal spars 15 located at the edges and in individual heavily loaded structural walls 4.

The fibrous composite reinforcing tapes 2 are located on a bottom half-shell of he enveloping element 1 and joined to the upper and lower end faces 5 of the transverse spars 14 or the profiled connection sections 4 located thereon by adhesive bonding. Instead of adhesive bonding, the connection between the profiled connection sections and the fibrous composite reinforcing tapes can be established using the resin of a fibrous composite reinforcing tape with which the profiled connection sections are brought into contact, as long as the fibrous composite reinforcing tape is not yet set. If the laminate of the fibrous composite tape is already set when being bonded to the structural element, it has to be suitably pre-treated for bonding to the structural element.

The fibrous composite reinforcing tape 2 is first laminated onto the inside of the enveloping element 1, which therefore does not have to be straight, but can be curved (FIGS. 7 and 8). The fibrous composite reinforcing tape 2 does not have to be arranged precisely parallel to the structural wall 4, because the bond is preferably based on the profiled connection section 4 only. The fibrous composite reinforcing tape can further run uninterrupted across several structural walls.

The fibrous composite reinforcing tape 2 can run across smaller areas outside the structural walls 4 (FIGS. 8 to 10).

The fibrous composite reinforcing tape 2 can project beyond the end of the structural walls 4 (FIGS. 9 and 10).

The fibrous composite reinforcing tape 2 can follow the curved contour of the enveloping element (FIG. 7).

A method according to the invention for producing a lightweight structure is described below.

The structural wall 4 of the lightweight structure 8 is almost completely produced in an automatic process. In this, it is provided that a filler material such as foam is first used as an intermediate layer 4a. This intermediate layer 4a is initially available in a plate-shaped form.

If the structural wall 4 is to have reinforcing bodies 16 later, at least one hole or recess is cut, drilled or milled into the filler material 4a. A reinforcing body 16 made of wood, e.g. birch or poplar plywood, is then installed into the hole. It may also be provided that further bodies, such as a metal bushing of aluminum, are installed into the intermediate layer 4a or the reinforcing bodies 16. For this purpose, the reinforcing body is produced with a ready-drilled or milled recess, and the metal insert is inserted into the recess and bonded there.

FIG. 8 shows a structural wall represented by a poplar plywood component 24, into which a birch plywood component 25 has been inserted, which has in turn been provided with aluminum bushes 26.

The intermediate layer 4a is then laminated to the first fiber outer layer 4b and the second fiber outer layer 4c and set.

In the next production step, recesses, holes etc. are first produced in the plate. To finish, one or more structural walls 4 of the desired shape are cut out from this blank.

The individual semi-finished products (intermediate layer, reinforcing element) and intermediate products (structural wall) are automatically handled, assembled and processed further by means of handling devices in individual processing steps.

One or more profiled connection sections 4 is/are then bonded to the structural wall 4. With this step, the structural wall is completed.

The enveloping element 1 or a base wall of the enveloping element 1 respectively is made of a fibrous composite material. A mold is provided for shaping this fibrous composite. In the completed state of the lightweight structure, it is provided that the fibers in the enveloping element 1 preferably extend diagonally to the end face 6 of the structural wall 4.

The fibrous composite reinforcing tape 2 is then applied in the regions where it is required or where the structural wall 4 is installed. The fibrous composite reinforcing tape 2 consists of reinforcing fibers embedded in a matrix material.

The structural wall 4 is joined to the enveloping element 1 by applying the structural wall under pressure on the not yet set fibrous composite reinforcing tape.

The not yet set matrix material bonds to the end face of the structural wall and in particular to the U-shaped profiled reinforcement section(s).

An upper wall of the enveloping element 1 with the reinforcing tape placed thereon and together with its mold is then placed on the lower wall and the structural wall(s).

It is in particular provided that several structural walls are assembled to form a skeleton, which is then joined to a lower half-shell of the enveloping element. An upper half-shell of the enveloping element is then fitted, and the entire lightweight structure is left to set. This process is preferably carried out in two molds placed on top of one another.

The method offers the advantage that the structural walls can be cut from plate material. The profiled connection sections are then adhesive-bonded to the structural walls.

On the inside of the wall or the shell of the enveloping element, the fibrous composite reinforcing tape is laminated. The structural walls are then bonded with the end face of the profiled connection section, preferably onto the not yet set reinforcing tape (FIG. 1).

It may also be provided that the fiber belt 7 is bonded to the end face of the structural wall and the profiled connection section is then bonded on top, or the fiber belt 7 is first bonded into the profiled connection section and then together with the profiled connection section onto the end face of the structural wall. This structural wall, enclosed at the end face in this way and reinforced (against tensile/compressive loads), can then be bonded to a further structural wall or to the enveloping element. A structural wall 4 with fiber belts 7 is preferably provided in exposed positions not covered by a fibrous composite reinforcing tape. The fiber belt 7 can be covered by the U-shaped profiled connection section 5 either completely or only in certain regions, in particular the end regions of the fiber belt 7. Such fiber belts can be fitted very easily and quickly. By providing the U-shaped profiled connection sections 5, such a fiber belt can be secured in the assembly process, and a good introduction of forces into the body of the structural wall can be ensured.

According to the invention, there is provided an aircraft assembly (assembly for aviation sports equipment, aeroplanes and other aircraft), i.e. a component for an aeroplane, aviation sports equipment and other aircraft such as helicopters, in particular a fuselage, a wing, a rudder, elevator, aileron, landing flap or a tail unit, made from a lightweight structure according to the invention by means of the method according to the invention.

### LIST OF REFERENCE NUMBERS

1 Enveloping element
1a Intermediate layer
1b First fiber outer layer
1c Second fiber outer layer
2 Fibrous composite reinforcing tape
3 Adhesive layer
4 Plate-shaped structural wall
4a Intermediate layer
4b First fiber outer layer
4c Second fiber outer layer
5 Profiled connection section
6 End face
7 Fiber belt
8 Lightweight structure
9 Base wall
10 Side wall
11 Central wing section
12 Lateral wing section
13 Skeleton
14 Transverse spars
15 Longitudinal spars
16 Reinforcing body
17 Connecting element
18 Recess
19 Landing flap
20 Actuating mechanism
21 Angle section
22 Location recess
23 Aileron
24 Poplar plywood component
25 Birch plywood component
26 Aluminum bush

1. Lightweight structure, in particular for aircraft, comprising a substantially plate-shaped structural wall and an enveloping element, each of which is formed from a fibrous composite material, wherein the structural wall is formed from a first fiber outer layer, an intermediate layer and a second fiber outer layer and at least in a sub-region of the end face of the structural wall, a U-shaped connecting profile having a base wall and two side walls is provided, wherein the base wall rests against the end face of the structural wall, and the side walls of the U-shaped profiled connection section rest against the outer surfaces of the first and second fiber outer layers and are joined thereto, and
the enveloping element comprises a fibrous composite reinforcing tape, wherein in the region of the fibrous composite reinforcing tape the end face of the structural wall rests against it and is joined thereto.

2-15. (canceled)

16. Lightweight structure according to claim 1,
wherein
the fibrous composite reinforcing tape and the structural wall are joined to one another in the region of the at least one U-shaped profiled connection section.

17. Lightweight structure according to claim 16,
wherein
the fibrous composite reinforcing tape is wider than the base of the U-shaped profiled connection section.

18. Lightweight structure according to claim 17,
wherein
the fibrous composite reinforcing tape extends parallel to the structural wall along the entire length or width of the enveloping element.

19. Lightweight structure according to claim 18,
wherein
the U-shaped profiled connection section is made up from two L-shaped profiled connection sections, which overlap one another with one leg each in the region of the end face of the structural wall to form the base.

20. Lightweight structure according to claim 19,
wherein
the several U-shaped profiled connection sections are located at the end face of the structural wall in sections.

21. Lightweight structure according to claim 20,
wherein
the U-shaped profiled connection sections are arranged at the end face of the structural wall at a distance from one another.

22. Lightweight structure according to claim 21,
wherein
the U-shaped profiled connection section is slotted in the region of the side walls, so that it is flexible in the region of the base.

23. Lightweight structure according to claim 1,
wherein
the fibrous composite reinforcing tape is wider than the base of the U-shaped profiled connection section.

24. Lightweight structure according to claim 1,
wherein
the fibrous composite reinforcing tape extends parallel to the structural wall along the entire length or width of the enveloping element.

25. Lightweight structure according to claim 1,
wherein
the U-shaped profiled connection section is made up from two L-shaped profiled connection sections, which overlap one another with one leg each in the region of the end face of the structural wall to form the base.

26. Lightweight structure according to claim 1,
wherein
the several U-shaped profiled connection sections are located at the end face of the structural wall in sections.

27. Lightweight structure according to claim 1,
wherein
the U-shaped profiled connection sections are arranged at the end face of the structural wall at a distance from one another.

28. Lightweight structure according to claim 1,
wherein
the U-shaped profiled connection section is slotted in the region of the side walls, so that it is flexible in the region of the base.

29. Method for producing a lightweight structure, wherein
a structural wall is formed from a first fiber outer layer, an intermediate layer and a second fiber outer layer and a U-shaped profiled connection section is placed in at least a sub-region of the end face of the structural wall and joined to the fiber outer layers, and in that
an enveloping element is provided with a fibrous composite reinforcing tape, whereupon the structural wall is joined by its end face to the fibrous composite reinforcing tape in the region of the U-shaped profiled connection section.

30. Method according to claim 29,
wherein
the structural wall is produced by laminating the intermediate layer to the two fiber outer layers, letting it set and then cutting it into a desired shape.

31. Method according to claim 29,
wherein
the structural wall is produced by using a filler material such as foam as an intermediate layer, wherein at least one hole, into which a reinforcing body made of a material which is harder than the filler material is installed, is cut into the filler material and the filler material together with the reinforcing body is laminated to the two outer layers and set.

32. Method according to claim 29,
wherein
a hole is drilled or milled into the set structural wall in the region of the reinforcing body.

33. Method according to claim 29,
wherein
a wooden body, a metal body and/or a fibrous composite body is/are used as a reinforcing body.

34. Method according to claim 29,
wherein
several structural walls are assembled to form a skeleton, whereupon the skeleton is joined to the enveloping element and a fibrous composite reinforcing tape is provided on the envelope at least parallel to a structural wall.

35. Method for producing a lightweight structure, comprising a substantially plate-shaped structural wall and an enveloping element, each of which is formed from a fibrous composite material, wherein the structural wall is formed from a first fiber outer layer, an intermediate layer and a second fiber outer layer and at least in a sub-region of the end face of the structural wall, a U-shaped connecting profile having a base wall and two side walls is provided, wherein the base wall rests against the end face of the structural wall, and the side walls of the U-shaped profiled connection section rest against the outer surfaces of the first and second fiber outer layers and are joined thereto, and the enveloping element comprises a fibrous composite reinforcing tape, wherein in the region of the fibrous composite reinforcing tape the end face of the structural wall rests against it and is joined thereto,
wherein
a structural wall is formed from a first fiber outer layer, an intermediate layer and a second fiber outer layer and a U-shaped profiled connection section is placed in at least a sub-region of the end face of the structural wall and joined to the fiber outer layers, and in that
an enveloping element is provided with a fibrous composite reinforcing tape, whereupon the structural wall is joined by its end face to the fibrous composite reinforcing tape in the region of the U-shaped profiled connection section.

36. Method according to claim 35,
wherein
the structural wall is produced by laminating the intermediate layer to the two fiber outer layers, letting it set and then cutting it into a desired shape.

37. Method according to claim 36,
wherein
the structural wall is produced by using a filler material such as foam as an intermediate layer, wherein at least one hole, into which a reinforcing body made of a material which is harder than the filler material is installed, is cut into the filler material and the filler material together with the reinforcing body is laminated to the two outer layers and set.

38. Method according to claim 37,
wherein
a hole is drilled or milled into the set structural wall in the region of the reinforcing body.

39. Method according to claim 38,
wherein
a wooden body, a metal body and/or a fibrous composite body is/are used as a reinforcing body.

40. Method according to claim 39,
wherein
several structural walls are assembled to form a skeleton, whereupon the skeleton is joined to the enveloping element and a fibrous composite reinforcing tape is provided on the envelope at least parallel to a structural wall.

41. Method for producing a lightweight structure, comprising
forming a structural wall from a first fiber outer layer, an intermediate layer and a second fiber outer layer;
placing a U-shaped profiled connection section in at least a sub-region of an end face of the structural wall and joined to the fiber outer layers;
providing an enveloping element with a fibrous composite reinforcing tape, and joining the structural wall by its end face to the fibrous composite reinforcing tape in the region of the U-shaped profiled connection section.
